(19) United States
(12) Patent Application Publication
(10) Pub. No.: US 2015/0018998 A1
(43) Pub. Date: Jan. 15, 2015

(54) VEHICLE WELDING QUALITY INSPECTION DEVICE AND THE METHOD THEREOF

(71) Applicant: Hyundai Motor Company, Seoul (KR)

(72) Inventor: Yong Joon Cho, Yongin-si (KR)

(73) Assignee: Hyundai Motor Company, Seoul (KR)

(21) Appl. No.: 14/145,345

(22) Filed: Dec. 31, 2013

(30) Foreign Application Priority Data
Jul. 9, 2013 (KR) 10-2013-0080400

(51) Int. Cl. G05B 15/02

(52) U.S. Cl. CPC G05B 15/02
USPC 700/109

(57) ABSTRACT

A vehicle welding quality inspection device for checking welding parts of a vehicle body transferred along a transferring line may include a welding part shooting unit fixed on an outside of the transfer line, shoots a welding inspection part of the vehicle body, and outputs the shot data to the controller, and a welding part vision sensor disposed on a front end of an arm of a robot, is moved thereby toward the welding point of the welding inspection part that is recognized by the controller, shoots the welding point, and the vision data to the controller.

### CROSS-REFERENCE TO RELATED APPLICATION

The present application claims priority of Korean Patent Application Number 10-2013-0080400 filed Jul. 9, 2013, the entire contents of which application is incorporated herein for all purposes by this reference.

### BACKGROUND OF INVENTION

1. Field of Invention

The present invention relates to a vehicle body assemble system. More particularly, the present invention relates to a vehicle welding quality inspection device that enables the inspection of spot welding parts of a vehicle body in a real time on a vehicle body line and the method thereof.

2. Description of Related Art

In general, car markers assemble tens of thousands of parts by many welding and assembly processes in every mass production process until a single car is produced.

In the mass production process of a vehicle, a vehicle body and the related components are transferred to a manufacturing process to enable production automation and the manufacturing process is efficiently managed. Particularly, the assembling of the vehicle body components is performed in a vehicle body build-up process (or a main buck process).

After a back panel is welded on a floor panel, both side panels, a roof panel, a roof rail, a cowl panel, and a package tray are welded thereon in the vehicle body build-up process through a vehicle body assembly system.

The vehicle body assembly system uses a side hanger and a side gate to control a side panel, sets the side panel on the floor panel, sets a roof panel, a roof rail, a cowl panel, and a package tray on the side panel, and welds their connection portions through a welding robot.

Meanwhile, the vehicle body that is assembled by a welding as described above is inspected to inspect welding parts on a separated inspection process so as to improve the assemble quality. Recently, the demand for improving the welding quality is increased, however it is hard to guarantee the quality after the welding.

As a conventional art, as shown in FIG. 1, if a vehicle body 101 moves to reach an inspection position, a welding quality inspection device 103 that is mounted on a robot approaches to a welding part of a vehicle body 101 to inspect welding quality of the welding part.

Here, the welding quality inspection device 103 approaches a welding part of a vehicle body 101 through a robot and shoots the welding part, then calculates position difference between the shoot data and a predetermined welding part, and determines whether the welding part is in an abnormal condition.

However, because the welding part is shot and the position difference between the shoot data and the predetermined welding part is calculated as described above in a conventional art, it needs separate time for seizing the position of the welding part and there is a drawback that information around the welding part cannot obtain.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for vehicle a welding quality inspection device and the method thereof having advantages of quickly calculating a position data of a welding part of a vehicle body and calculating a shape and a concave spot depth of the weld part aside the position data of the welding part.

A vehicle welding quality inspection device for checking welding parts of a vehicle body that is transferred along a transferring line according to various aspects of the present invention may include a welding part shooting unit that is fixed on an outside of the transfer line, shoots a welding inspection part of the vehicle body, and outputs the shot data to the controller, and a welding part vision sensor that is disposed on a front end of an arm of a robot, is moved thereby toward the welding point of the welding inspection part that is recognized by the controller, shoots the welding point, and the vision data to the controller.

The welding part vision sensor may include a lighting portion that radiates light toward the welding point and a camera portion that shoots the welding point.

The lighting portion may be arranged along an edge portion of the camera portion.

The controller may analyze the vision data of the welding point that is acquired from the welding part vision sensor to determine whether the welding portion is normal or not.

The welding part vision sensor may include a lighting portion that radiates light toward the welding point and a camera portion that shoots the welding point, and the position of the camera portion is varied by the robot in both side directions with a predetermined angle based on a center of the welding point.

The welding part vision sensor may include a lighting portion that radiates light toward the welding point and a camera portion that shoots the welding point, and three lighting portions are arranged with an interval of 120 degrees.

The controller may analyze the vision data that is acquired by the welding part vision sensor to calculate the shape and the concave spot depth of the welding point.

A vehicle welding quality inspection method that shoots a welding point of a vehicle body that is transferred along a transfer line according to various aspects of the present invention may include Shooting a welding inspection part of the vehicle body through a welding part shooting unit from an outside of the transfer line and outputting the shot data of the welding inspection part to a controller, analyzing the shot data of the welding inspection part of the controller and calculating the position data of the welding point for the welding inspection part, transmitting the position data of the welding point through the controller and moving a welding part vision sensor toward the welding point, shooting the welding point through the welding part vision sensor and outputting the shot data of the welding point to the controller, and analyzing the shot data of the welding point through the controller to determine whether the welding point is normal or not.

The position of the welding part vision sensor may be varied by the robot in both side directions with a predetermined angle based on a center of the welding point so as to radiate light toward the welding point and shoot the welding point.

The welding part vision sensor may radiate light toward the welding point with an interval of 120 degrees from an outside of a center of the welding point and shoots the welding point.

The controller may analyze the shot data of the welding point and calculates the shape and the concave spot depth of the welding point.

Various aspects of the present invention can shoot a welding inspection part through a welding part shooting unit, calculate a position data of welding points of welding inspection part, transfer the position data to a robot, and move a welding part vision sensor to a welding point of the welding inspection part.

Accordingly, a position data of the welding point of a welding inspection part of a vehicle body may be quickly calculated and a cycle time of a welding quality inspection process may be reduced.

Also, a shape and a concave spot depth of the welding point may be calculated to improve the reliability of the welding quality inspection aside a position data of a welding point.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a usage example of a vehicle welding quality inspection device according to a conventional art.

FIG. 2 is a schematic diagram showing a configuration of an exemplary vehicle welding quality inspection device according to the present invention.

FIG. 3 is a schematic diagram showing a welding part vision sensor that is applied to an exemplary vehicle welding quality inspection device according to the present invention.

FIG. 4 is a flow chart for explaining an exemplary vehicle welding quality inspection method according to the present invention.

FIG. 5 and FIG. 6 show exemplary variations of a welding part vision sensor that is applied to an exemplary vehicle welding quality inspection device according to the present invention.

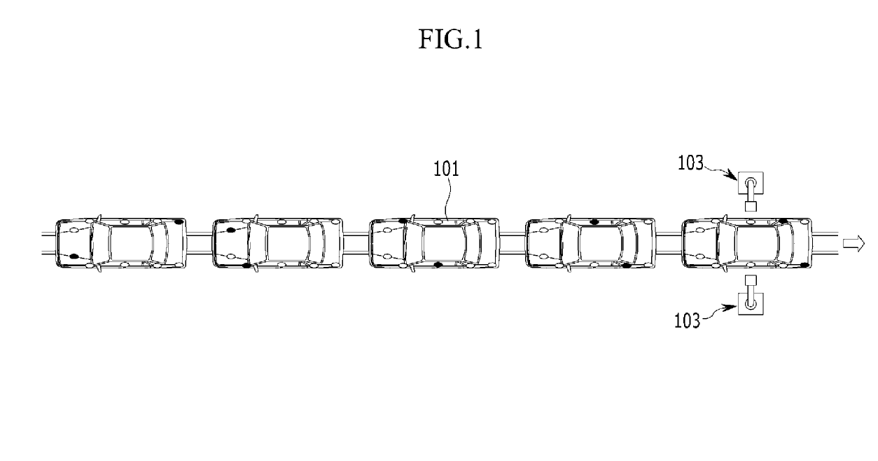

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Accordingly, the drawings and description are to be regarded as illustrative in nature and not restrictive, and like reference numerals designate like elements throughout the specification.

Also, the size and thickness of each element are arbitrarily shown in the drawings, but the present invention is not necessarily limited thereto, and in the drawings, the thickness of layers, films, panels, regions, etc., are exaggerated for clarity.

In the following detailed description, in order to distinguish constituent elements of the same name, the constituent elements have names of a first, a second, and a third, and the first, the second, and the third are not limited to order thereof.

In this specification, unless explicitly described to the contrary, the word “comprise” and variations such as “comprises” or “comprising”, will be understood to imply the inclusion of stated elements but not the exclusion of any other elements.

Also terms of “. . . unit”, “. . . means”, “. . . portion”, “. . . element” that are mentioned in the specification signifies a unit of comprehensive configuration that performs at least one function or operation.

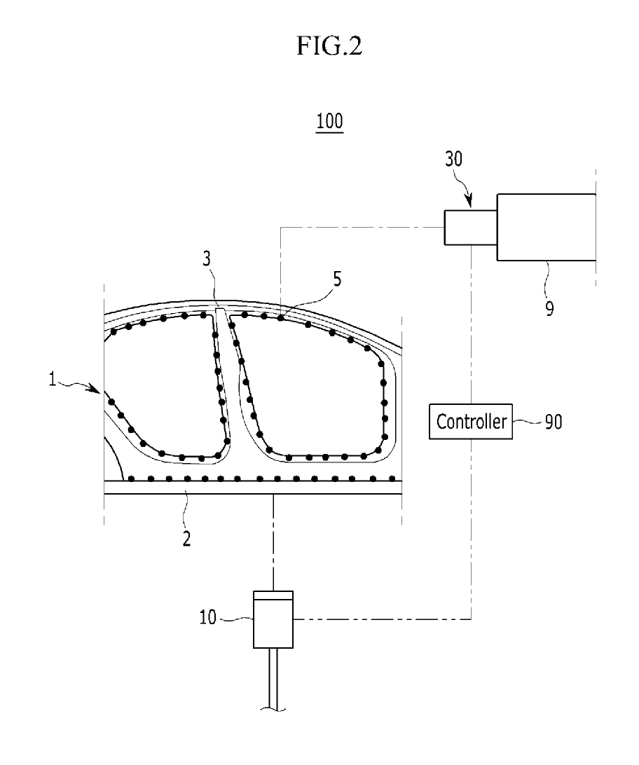

FIG. 2 is a schematic diagram showing a configuration of a vehicle welding quality inspection device according to various embodiments of the present invention.

Referring to FIG. 2, a vehicle welding quality inspection device 100 according to various embodiments of the present invention can be applied to a vehicle body assembly process that welds a both side panel, a roof panel, a roof rail, a cowl panel, and a package tray to assemble them each other, after joining a back panel on a floor panel.

For example, various panels are assembled by a spot welding in a vehicle body assembly process and the assembled vehicle body 1 can be transferred to a welding quality inspection process along a transfer line 2, in which various embodiments of the present invention is applied to the process.

In this case, a welding inspection part 3 of a vehicle body 1 that is transferred along a transfer line 2 is recognized in a welding quality inspection process, the welding point 5 of the welding inspection part 3 is shot to be able to determine whether the welding point 5 is normal or not.

A vehicle welding quality inspection device 100 according to various embodiments of the present invention has a structure that can quickly calculate a position data of a welding point 5 of a welding inspection part 3 of a vehicle body 1 within a predetermined time.

For this, a vehicle welding quality inspection device 100 according to various embodiments of the present invention basically includes a welding part shooting unit 10, a welding part vision sensor 30, and a controller 90.

In various embodiments of the present invention, the welding part shooting unit 10 shoots welding inspection part 3 of a vehicle body 1 that is transferred along a transfer line 2 and outputs the shot data of the welding inspection part 3 to the controller 90.

The welding part shooting unit 10 is fixed on an outside of the transfer line 2 to shoot a welding inspection part 3 of a vehicle body 1, for example a welding inspection part of a whole side assembly.

Here, the controller 90 acquires the shot data of the welding inspection part 3 from the welding part shooting unit 10 and analyzes the shot data to be able to calculate a position data of the welding point 5 for the welding inspection part 3.

In various embodiments of the present invention, the welding part vision sensor 30 approaches the welding points 5 of the welding inspection part that is recognized through the controller 90, shoots (or films) the welding points 5, and outputs the shot data to the controller 90.

The welding part vision sensor 30 is disposed at a front end of an arm of a robot 9. The robot 9 receives position data of the welding points 5 that is acquired through the welding part shooting unit 10 to be able to move the welding part vision sensor 30 to the welding points 5.

The welding part vision sensor 30 includes a camera portion 31 shooting the welding point 5 and a lighting portion 33 radiating light to the welding point 5.

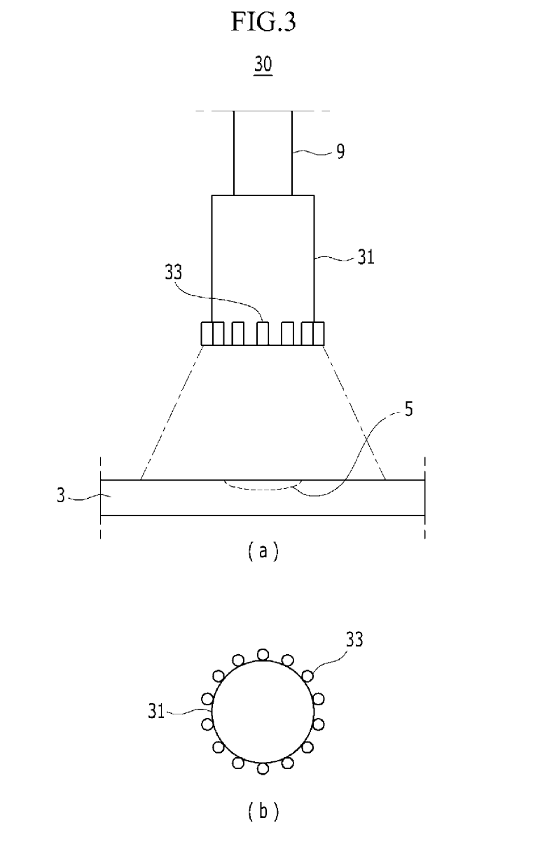

The camera portion 31 is disposed on a front end of an arm of the robot 9, and the lighting portion 33, as shown in FIG. 3, can be arranged along an edge portion of the camera portion 31.

In this case, the camera portion 31 approaches a central side of the welding point 5 to be able to shoot the welding point 5, and the lighting portions 33 can radiate light on an outside of a central portion of the welding point 5.

Meanwhile, the controller 90 acquires the vision data of the welding point 5 that is shot by the camera portion 31 of the welding part vision sensor 30, and analyzes the vision data to be able to determine whether the welding point 5 is normal or not.

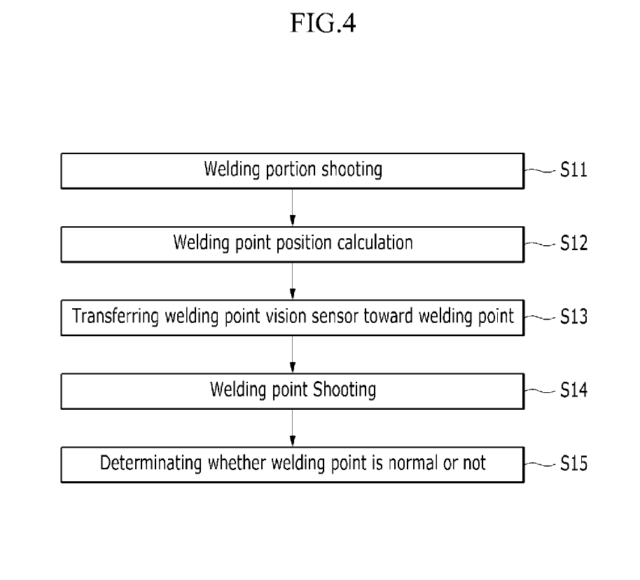

A vehicle welding quality inspection method using a vehicle welding quality inspection device 100 according to various embodiments of the present invention as described above will be described with reference to the previously disclosed drawings and FIG. 4.

FIG. 4 is a flow chart for explaining a vehicle welding quality inspection method according to various embodiments of the present invention.

Referring to the previously disposed drawings and FIG. 4, a vehicle body 1 in which every kind of panels are welded thereon is transferred to a welding quality inspection process along a transfer line 2 in various embodiments of the present invention.

In this condition, the welding inspection part 3 of the vehicle body 1 is shot by the welding part shooting unit 10 from an outside of the transfer line 2 and the vision data of the welding inspection part 3 is outputted to the controller 90 (S11) in various embodiments of the present invention (S11).

Thus, the controller 90 analyzes the vision data of the welding inspection part that is acquired from the welding part shooting unit 10 and calculates the position data of the welding points 5 for the welding inspection part 3 (S12).

Then, the controller 90 transmits the position data of the welding points 5 for the welding inspection part 3 to the robot 9. The robot 9 moves the welding part vision sensor 30 to the vicinity of the welding point 5 based on the position data (S13). The welding part vision sensor 30 can be positioned on the vicinity of a central side of the welding point 5.

Continuously, the lighting portions 33 of the welding part vision sensor 30 radiates lighting toward a central side of the welding point 5, and the camera portion 31 of the welding part vision sensor 30 shoots the welding point 5 and outputs the vision data of the welding point 5 to the controller 90 (S14).

Hence, the controller 90 acquires the vision data of the welding point 5 that is shot by the camera portion 31 of the welding part vision sensor 30, and analyzes the vision data to determine whether the welding point 5 is normal or not (S15).

As described above, a vehicle welding quality inspection device 100 according to various embodiments of the present invention shoots the welding inspection part 3 through the welding part shooting unit 10, calculates position data of the welding points for the welding inspection part 3 through the controller 90, transmits the position data to the robot 9, and moves the welding part vision sensor 30 toward the welding points 5 of the welding inspection part 3.

Accordingly, because the position data of the welding point 5 for welding inspection part 3 of the vehicle body 1 can be accurately calculated within a predetermined short time in various embodiments of the present invention, the cycle time of the welding quality inspection process can be reduced.

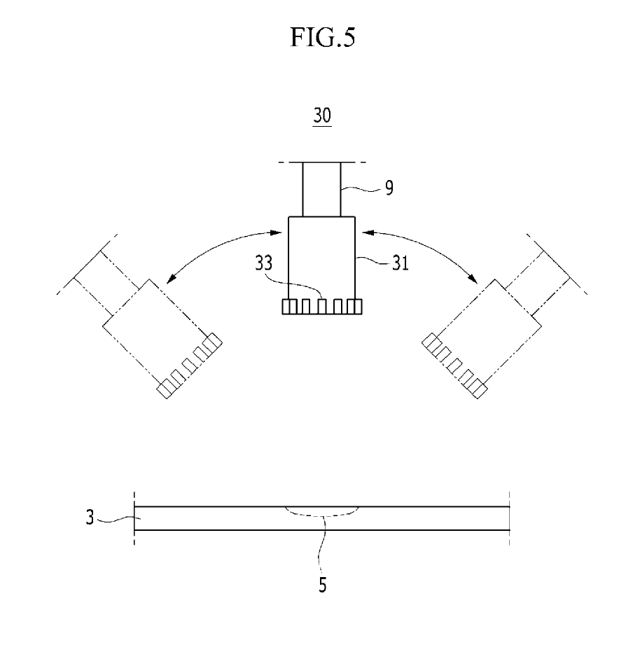

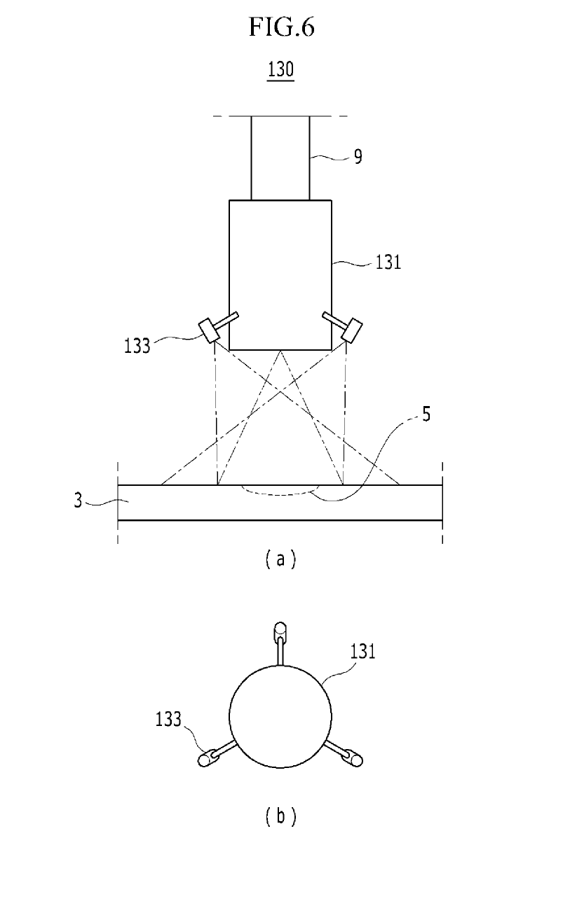

FIG. 5 and FIG. 6 show exemplary variations of a welding part vision sensor that is applied to a vehicle welding quality inspection device according to various embodiments of the present invention. Equal reference numeral is applied in the FIG. 5 corresponding to the previously disclosed constituent elements.

Referring to FIG. 5, a welding part vision sensor 30 according to various embodiments of the present invention has a structure that the position of the camera portion 31 is varied by the robot 9 as much as a predetermined angle (for example 120 degrees) in both directions based on a center position of the welding point 5.

That, the camera portion 31 of welding part vision sensor 30 shoots the welding point 5 from a center side of the welding point 5, is moved by the robot 9 in one side direction as much as 120 degrees to shoot the welding point 5, and is moved in the other side direction as much as 120 degrees based on a center direction of the welding point 5 to shoot the welding point 5.

Here, the lighting portion 33 of the welding part vision sensor 30 can radiates light toward the welding point 5 while the camera portion 31 shoots the welding point 5 from a predetermined variable position.

Accordingly, the position of the camera portion is varied by the robot 9 in both side directions based on a center side of the welding point 5 in various embodiments so as to radiate light toward the welding point 5 and shoot the welding point 5, and the vision data is outputted to the controller (90, FIG. 2).

Thereby, the controller 90 analyzes the vision data of the welding point 5 that is acquired from the welding part vision sensor 30 in an exemplary variation and calculates the shape and the concave spot depth of the welding point 5, and can reliably determine whether the welding point 5 is normal or not.

Meanwhile, referring to FIG. 6, in various embodiments of the welding part vision sensor 130 in the present invention, three lighting portions 133 are arranged on the camera portion 131 with an interval of 120 degrees.

That is, the lighting portions 133 are disposed on the camera portion 131 in a radial direction with an interval of 120 degrees based on the center side of the welding point 5, and the lighting can be radiated from an outside of the center side of the welding point 5.

Here, three lighting portions 133 are sequentially operated to be able to radiate light from an outside of a center of the welding point 5, and the camera portion 131 shoots the shade that is formed by the lighting portion 133 on the welding point 5 and outputs the vision data to the controller 90.

Accordingly, the light is radiated toward the welding point 5 from an outside of a center of the welding point 5 with an interval of 120 degrees, the welding point 5 is shot to calculate the shape and the concave spot depth of the welding point 5, and the abnormality of the welding point 5 can be reliably determined based on the calculated data.

For convenience in explanation and accurate definition in the appended claims, the terms front and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle welding quality inspection device for checking welding parts of a vehicle body transferred along a transferring line, comprising:
a welding part shooting unit fixed on an outside of the transfer line, shoots a welding inspection part of the vehicle body, and outputs the shot data to the controller; and
a welding part vision sensor disposed on a front end of an arm of a robot, is moved thereby toward the welding point of the welding inspection part that is recognized by the controller, shoots the welding point, and the vision data to the controller.

2. The vehicle welding quality inspection device of claim 1, wherein the welding part vision sensor includes a lighting portion that radiates light toward the welding point and a camera portion that shoots the welding point.

3. The vehicle welding quality inspection device of claim 2, wherein the lighting portion are arranged along an edge portion of the camera portion.

4. The vehicle welding quality inspection device of claim 3, wherein the controller analyzes the vision data of the welding point that is acquired from the welding part vision sensor to determine whether the welding portion is normal or not.

5. The vehicle welding quality inspection device of claim 1, wherein the welding part vision sensor includes a lighting portion that radiates light toward the welding point and a camera portion that shoots the welding point, and the position of the camera portion is varied by the robot in both side directions with a predetermined angle based on a center of the welding point.

6. The vehicle welding quality inspection device of claim 1, wherein the welding part vision sensor includes a lighting portion that radiates light toward the welding point and a camera portion that shoots the welding point, and three lighting portions are arranged with an interval of 120 degrees.

7. The vehicle welding quality inspection device of claim 5, wherein the controller analyzes the vision data that is acquired by the welding part vision sensor to calculate the shape and the concave spot depth of the welding point.

8. A vehicle welding quality inspection method that shoots a welding point of a vehicle body transferred along a transfer line, comprising:
shooting a welding inspection part of the vehicle body through a welding part shooting unit from an outside of the transfer line and outputting the shot data of the welding inspection part to a controller;
analyzing the shot data of the welding inspection part of the controller and calculating the position data of the welding point for the welding inspection part;
transmitting the position data of the welding point through the controller and moving a welding part vision sensor toward the welding point;
shooting the welding point through the welding part vision sensor and outputting the shot data of the welding point to the controller;
analyzing the shot data of the welding point through the controller to determine whether the welding point is normal or not.

9. The vehicle welding quality inspection method of claim 8, wherein the position of the welding part vision sensor is varied by the robot in both side directions with a predetermined angle based on a center of the welding point so as to radiate light toward the welding point and shoot the welding point.

10. The vehicle welding quality inspection method of claim 8, wherein the welding part vision sensor radiates light toward the welding point with an interval of 120 degrees from an outside of a center of the welding point and shoots the welding point.

11. The vehicle welding quality inspection method of claim 9, wherein the controller analyzes the shot data of the welding point and calculates the shape and the concave spot depth of the welding point.
